(19) United States
(12) Patent Application Publication
(10) Pub. No.: US 2017/0041286 A1
(43) Pub. Date: Feb. 9, 2017

(54) System and Method for the Display, Use, Organization and Retrieval of Like Item Content within a Structured Content Management System

(71) Applicant: Anthony I. Lopez, JR., Dana Point, CA (US)

(72) Inventor: Anthony I. Lopez, JR., Dana Point, CA (US)

(21) Appl. No.: 14/818,076

(22) Filed: Aug. 4, 2015

(51) Int. Cl. H04L 29/12; H04L 29/08

(52) U.S. Cl. CPC H04L 61/1582; H04L 61/1511; H04L 67/02

(57) ABSTRACT

The present invention includes a system and method for providing the user like item content which are products from one or more online vendors for purchase, and storage and retrieval of content within a structured content management system. The invention allows users to simultaneously organize and manage all content including like item content which are products found on the Internet within a common secure Smart Server that aids in categorizing and classifying the like item content by way of associations, URL, supporting URL, content detail URL and/or originating URL. The system would not only provide users with access to the URL where the like item content was first found but also allow users future retrieval of the like item content whether or not the like item content's supporting URL or originating URL still exists or has been deleted or modified. The system and method may be used on any and all devices including but not limited to desktop/laptop, mobile and tablet devices. Content shared through the system is automatically rendered throughout all devices using the system. The present invention allows users to search for specific content by way of who, what, when and where. Using this system would save time from multiple processes of comparing goods and services, provide users with the benefit of more cost effective and trustworthy online vendors, and allow users to quickly extract and organize desired content for later retrieval.

### DEFINITIONS

Prior to describing the present invention, it is useful to provide definitions for some key terms used herein.

Content: broadly interpreted to include, without exclusion, digital resource that is, or could be accessed on the Internet such as image files, audio files, text files, video files, products and any combinations and equivalents thereof.

Desired Content: broadly interpreted to include, without exclusion, any specific wanted data on a digital content platform, such as images, audio, text, video, and any combinations and equivalents thereof.

Atomic Content: broadly interpreted as a single element such as an image, text, or video that is not naturally divisible into smaller units.

Composite Content: broadly interpreted as a content type which has many atomic resources within it, for example, a html web page consisting of many script and image files.

Associated Content: broadly interpreted to include, without exclusion, any and all data of interest, desired or not, associated with an element—whether said element is atomic or composite. Most often, an element of content will have associated content within its composite parent content item.

URL (Uniform Resource Locator): broadly interpreted as a character string that constitutes a reference to atomic and/or composite resources on the World Wide Web.

Supporting URL or Source Location: a URL describing the location of an element or atomic content, which makes up composite content.

Originating URL or Source Location: a URL where original content comes from (typically composite).

Content Detail URL: some atomic content that is embedded in a particular instance of composite content will have associated code indicating a URL which provides additional information about said content. This URL is referred to as the content detail URL.

Unstructured Content: broadly interpreted as information that either does not have a pre-defined data model or is not organized in a pre-defined manner.

Content Management System: broadly interpreted as a computer application that allows publishing, editing, modifying, organizing and deleting of content as well as maintenance from a central interface.

Web Browser (or browser): broadly interpreted as retrieving, presenting, and traversing information resources on the World Wide Web.

Image: broadly interpreted as a visual representation of a person, object, thing, product, or scene in a digital form that may be for purchase and is machine-readable and/or machine-storable.

Like item content: broadly interpreted as more than one content that is the same or similar to the original.

Display of Like item content: broadly interpreted as presenting content in any medium that is the same of similar to the original.

### BACKGROUND OF THE INVENTION

The Internet carries an extensive range of information resources and services that users use as a searching tool for personal and business purposes. Users can access the Internet from almost anywhere through personal computers, mobile devices, game consoles and any other device connected to the network. The Internet has become increasingly popular for purchasing goods or products through the web browser or through mobile applications. Users use web browsers such as Safari, Mozilla, Internet Explorer and other various browsers to access websites where they find desired content. Users use applications on mobile devices to purchase products conveniently from anywhere through the network.

Online websites or mobile applications that provide products for purchase are accessible via an electronic communication network such as the Internet. Users frequently search and browse the Internet through web browsers or mobile applications to locate varying products that result in a serendipitous presentation of an overwhelming number of products. Once users find a desired product from the Internet that they want to purchase, users will often search other online vendors that are selling the same product for comparison. Often users may not purchase desired products from the websites or applications where they originally found them because the purchase may be detrimental to users for various reasons. For example, the cost of the product may be higher or vary from each online vendor that provides and sells the same product and/or the online vendors found are not familiar to users and may be untrustworthy.

Often, users search and browse content through website browsers and mobile applications without the desired purpose to purchase products. As users search and browse, they frequently stumble upon an image that is also a product or products they decide they want to purchase but want to find the best cost and/or a trustworthy online vendor. Users are not provided with an instantaneous correlation with other online vendors such as Amazon that also provide the like item content which may be more cost effective and from a reliable source. Users must independently search and find other online vendors that may have the same desired like item content.

In addition, users typically select and store desired content (goods and services) found on the Internet on hard disk drives, memory devices, cloud storage or other storage and retrieval systems for later purchase, reference or other purposes. While users can now access the desired content they do not necessarily have the ability of retrieving the desired content from its originating source. Also if the user desires to retrieve the desired content from its originating source, the desired content may be gone or hidden for various reasons. No further relationship exists with the selected desired content that has been stored. Conventional storage systems do not aid desired content stored relative to assisting in a system that helps categorize said content and classifies it by way of associations, URL, supporting URL, content detail URL, and originating URL.

Typically, the desired content is stored on a platform or other storage device (computer desktop, external hard drive, etc.) and therefore the content is unstructured as it does not have a pre-defined data model or is not organized in any pre-defined manner. Over time, the amount of content a member has stored increases significantly. Since the content is unstructured, retrieval of specific content can be overwhelming as searching for a particular desired content typically requires users to scroll through a massive aggregate of content a member may have acquired over time. Typically a user cannot search through content on other storage devices because it is unstructured and uncategorized. Further, users are unable to search their content by way of who, what, when, and where. Due to the lack of a viable content management system, which would organize content for search and retrieval the user is left with the tenuous, time-consuming task of looking for that analogy of a needle in an overgrowing, unorganized content haystack.

Therefore a solution that would be more practical and desirable would be to have a system and method for providing like item content from one or more other online vendors and storage and retrieval of desired content within a structured content management system. A secure content management system assists users in converting all of their unstructured content into organized, departmentalized, structured content for specific search, retrieval and communication of content through instantaneous sharing within the system. It would be desirable to capture and store content that associates the content with its purpose, the URL, supporting URL and originating URL. It would also be desirable for the user to be able to ensure the persistence of stored content whether or not their supporting URL or originating URL still existed. This frees the system from reliance on third parties to maintain and not change content.

### BRIEF SUMMARY OF THE INVENTION

The present invention includes a system and method for providing the user like item content which are products from one or more online vendors for purchase, and storage and retrieval of content within a structured content management system. The invention allows users to simultaneously organize and manage all content including like item content which are products found on the Internet within a common secure Smart Server that aids in categorizing and classifying the like item content by way of associations, URL, supporting URL, content detail URL and/or originating URL. The system would not only provide users with access to the URL where the like item content was first found but also allow users future retrieval of the like item content whether or not the like item content's supporting URL or originating URL still exists or has been deleted or modified. The system and method may be used on any and all devices including but not limited to desktop/laptop, mobile and tablet devices. Content shared through the system is automatically rendered throughout all devices using the system. The present invention allows users to search for specific content by way of who, what, when and where. Using this system would save time from multiple processes of comparing goods and services, provide users with the benefit of more cost effective and trustworthy online vendors, and allow users to quickly extract and organize desired content for later retrieval.

The following description is presented to enable one of ordinary skill in the art to make and use the invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

### BRIEF DESCRIPTION OF THE DRAWINGS

FIG. 1 is a block diagram illustrating an exemplary embodiment of the system and method containing multiple hardware and software components for providing like item content and storage and retrieval of content within a structured content management system according to the present invention;

FIG. 2 is a flowchart illustrating an exemplary embodiment of a method of how the system determines, identifies, and stores specific elements according to the present invention;

FIG. 3 is a flowchart illustrating a second exemplary embodiment of a method of how the system determines, stores and categorizes specific elements according to the present invention;

FIG. 4 is a flowchart illustrating an exemplary embodiment of a method of how the system is initialized from a client through the server process to view content according to the present invention;

FIG. 5 is a flowchart illustrating a second exemplary embodiment of a method of how the system is initialized from a client through the server process to retrieve content according to the present invention;

FIG. 6 is a flowchart illustrating a second exemplary embodiment of a method of how the system is initialized from a client through the server process to search content according to the present invention;

### DETAILED DESCRIPTION

It should be appreciated that the present invention can be implemented in numerous ways, including as a process, or apparatus, a system, or a computer readable medium such as a computer readable storage medium or a computer network wherein program instructions are sent over optical or electronic communication links. It should be noted that the order of disclosed processes may be altered within the scope of the invention.

A detailed description of one or more preferred embodiments of the invention is provided below along with accompanying figures that illustrate by way of example the principles of the invention. While the invention is described in connection with the embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

An element according to the present invention encompasses digital content to include but not limited to meta data, text, image files, sound files, and video files. In order for the invention to properly store and distribute content, content is sent through a smart server wherein they are processed to either a database server or media store server where the content is separated into component content parts and associated URL, supporting URL, content detail URL, and originating URL. On the database server textual elements are indexed while on the media store server if applicable, a unique identifier is generated in association with an element that can be anything from an image file or video file. Requests from users are then sent back through the smart server to the user's browser where the user can view all content containing the request. If pre-existing content is sent through the system, the system will filter out the duplicate content, replacing it with a unique identifier. In this manner, media is stored and retrieved without duplication, while still allowing varied meta data to be associated with said content.

In an exemplary embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device. The medium can be an electronic, magnetic, optical, electromagnetic, infrared, or semiconductor system (or apparatus of device) or a propagation medium.

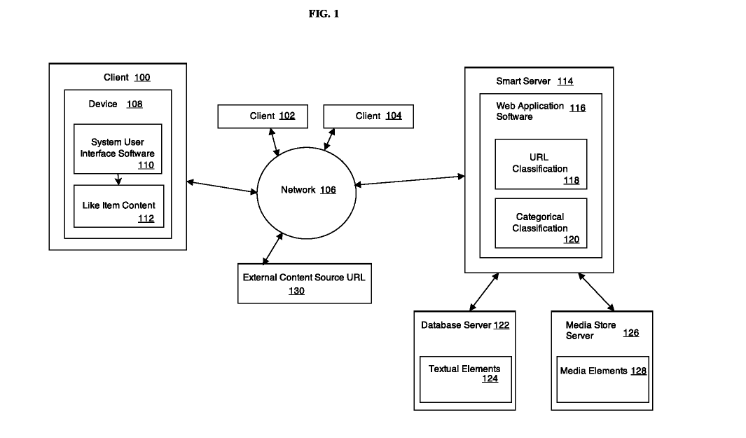

FIG. 1 is a block diagram illustrating an exemplary embodiment of a system displaying multiple hardware and software components of a system for providing like item content and originating URL for content. A client's 100 device 108 interacting with a System User Interface Software 110 which displays like item content 112 for desired content, interacts and sends client 100 commands through the network 106 to a Smart Server 114 where Web Application Software 116 executes said commands to determine, classify, store, and retrieve content by way of URL Classification 118 and Categorical Classification 120 from an external content source URL 130. The content is processed either to a Database Server 122 where textual element indexing 124 occurs or to a Media Store Server 126 where media elements are assigned unique identifiers 128 in association with relevant applicable content.

The client 100 can then retrieve the content from the Smart Server 114 through the browser 108 where the System User Interface Software 110 requests all the elements or parts of the elements. All separated textual elements 124 from Database Server 122 and media elements with unique identifiers 128 from Media Store Server 126 are now transferred to the client 100 through the Web Application Software 116 from the Smart Server 114 through the network 106 interacting with the System User Interface Software 110 where the client 100 views the content on a browser 108. The remainder of the elements may be retrieved at a later stage or not at all, as it is stored in the Smart Server 114.

Other clients, as represented in 102 and 104 running on other system user interface software may also be connected to the network 106. If the content from the URL is changed, moved, deleted or its access restricted, these clients will be unable to utilize said URLs for content retrieval. Whereas client 100 of this invention will be able to retrieve from the Smart Server 116 the archived content independently of its external existence on its originating server.

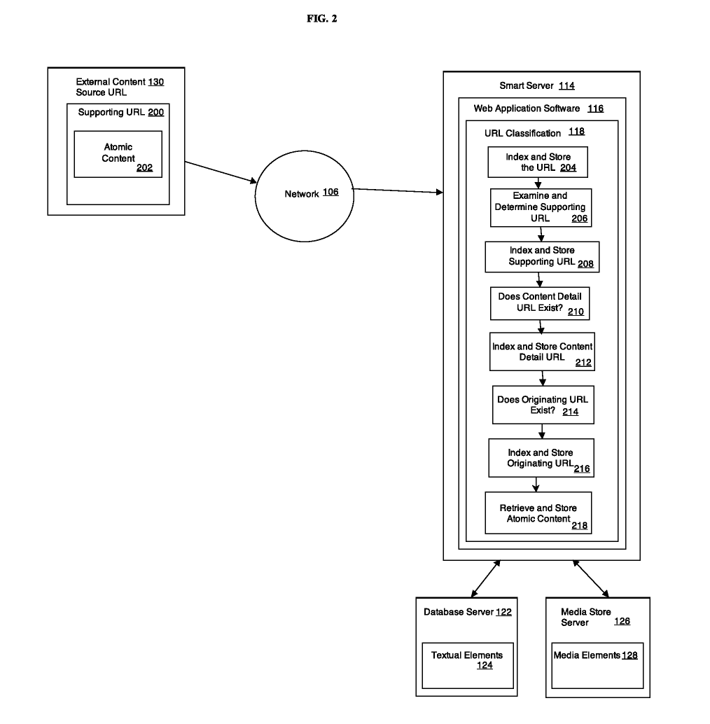

FIG. 2 is a flowchart that further illustrates an exemplary embodiment of a system and method of URL Classification 118 displaying through multiple hardware and software components whereby the atomic content 202 with a supporting URL 200 from an external content source URL 130 is retrieved through the network 106 by the Smart Server 114 where the Web Application Software 116 indexes and stores the URL 204, examines and determines supporting URL 206, indexes and stores supporting URL 208, determines content detail URL 210, indexes and stores content detail URL 212, determines originating URL 214, indexes and stores originating URL 216, and retrieves and stores atomic content 218.

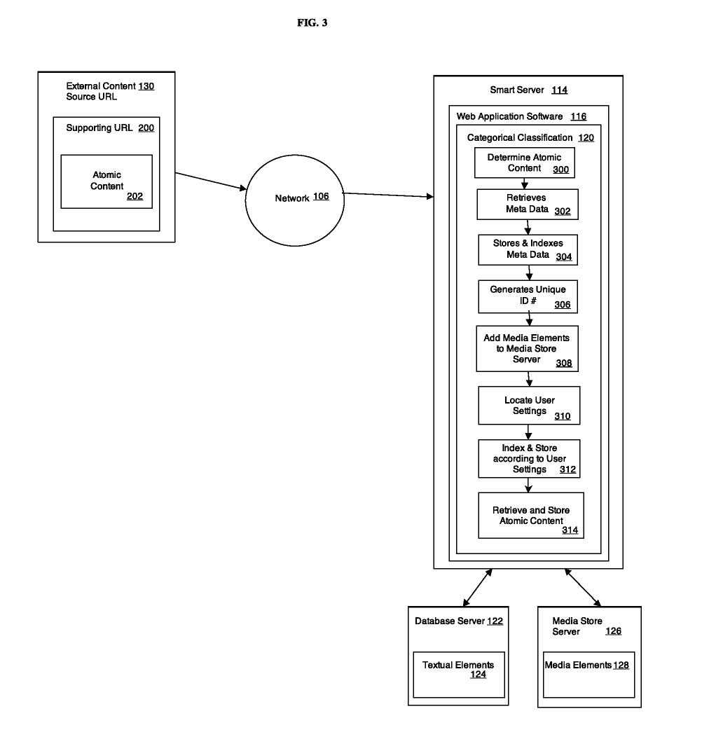

FIG. 3 is a flowchart that further illustrates an exemplary embodiment of a system and method of Categorical Classification 120 displaying through multiple hardware and software components whereby the atomic content 202 with a supporting URL 200 on an external content source URL 130 is retrieved through the network 106 by the Smart Server 114 where the Web Application Software 116 determines atomic content 300, retrieves meta data 302, stores and indexes meta data 304, generates unique id #306, adds media elements to media store server 308, locates user settings 310, indexes and stores according to user settings 312, retrieves and stores atomic content 314.

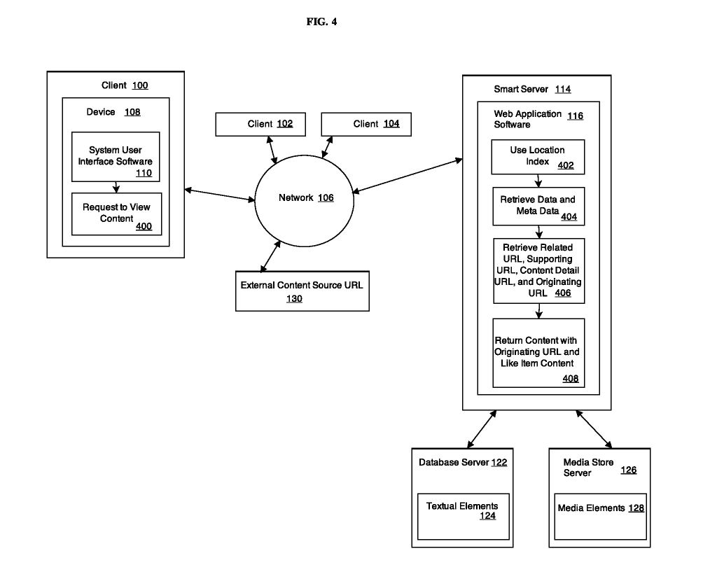

FIG. 4 is a flowchart that further illustrates an exemplary embodiment of a system and method displaying through multiple hardware and software components whereby requests to view content 400 sent from the client 100 interacting with the System User Interface Software 110 through the network 106 are received by the Smart Server 114 where the Web Application Software 116 uses location index 402, retrieves data and meta data 404, retrieves related URL, supporting URL, content detail URL and originating URL 406, and returns content with originating URL and like item content 408 to the client 100 through the network 106 interacting with the System User Interface Software 110 where it is viewed on a browser 108.

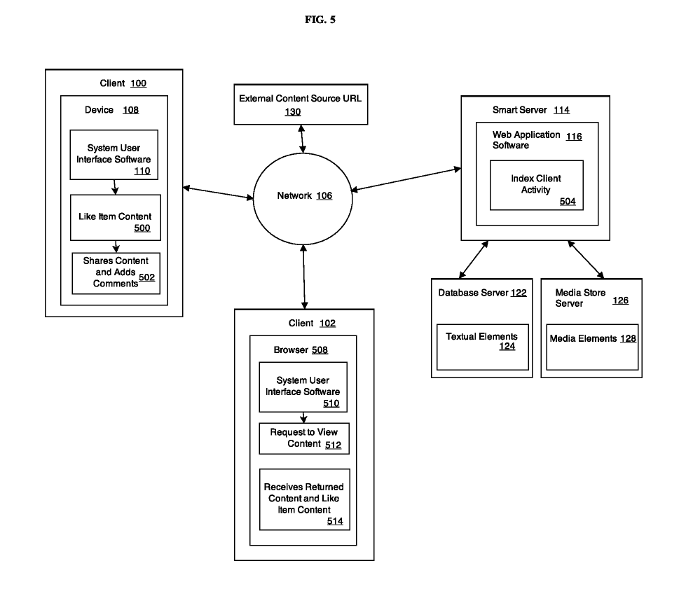

FIG. 5 is a flowchart that further illustrates an exemplary embodiment of a system and method displaying through multiple hardware and software components whereby client 100 shares content and adds comments 502 on like item content 500 interacting with the System User Interface Software 110 sent through the network 106 are received by the Smart Server 114 where the Web Application Software 116 indexes client activity 504. Requests to view content 512 sent from client 102 on a browser 508 interacting with a System User Interface Software 510 through the network 106 are received by the Smart Server 114 where the Web Application Software 116 indexes client activity 504 and client 102 receives returned content and like item content 514.

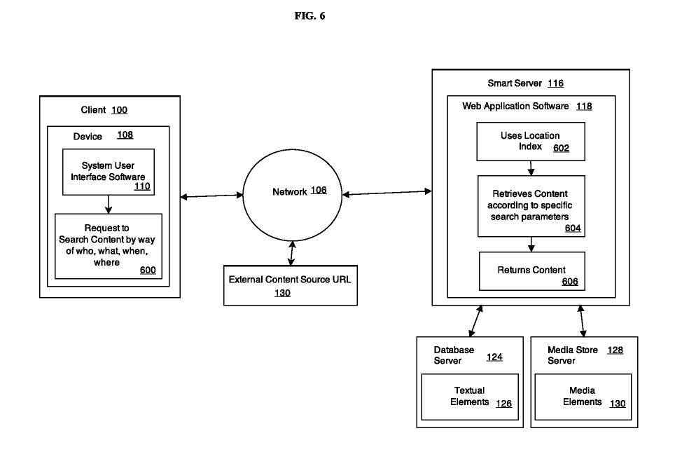

FIG. 6 is a flowchart that further illustrates an exemplary embodiment of a system and method displaying through multiple hardware and software components whereby client 100 requests to search content by way of who, what, when, where 600 interacting with the System User Interface Software 110 sent through the network 106 are received by the Smart Server 116 where the Web Application Software 118 uses location index 602, retrieves content according to specific search parameters 604, and returns content 606.

What is claimed is:

1. A method, for providing like item content and storage and retrieval of content within a structured content management system, the method comprising: of an operation to be performed on a smart server; perform the following steps on a smart server which further interacts with the appropriate Database Server and Media Store Server to: classify, store, display, determine, and retrieve content; wherein the client device does not block thereby allowing one or more operations to be performed at the client device; receiving from the smart server the content, like item content, its URL, its supporting URL, and originating URL.

2. A method as recited in claim 1, the method comprising: of an operation to be performed on a smart server by way of URL Classification; in response to the client request, perform the following steps on a smart server which further interacts with the Database Server and Media Store Server to: index and store the URL, examine and determine supporting URL, index and store supporting URL, determine content detail URL, index and store content detail URL, determine originating URL, index and store originating URL, retrieve and store atomic content.

3. A method as recited in claim 1, the method comprising: of an operation to be performed on a smart server by way of Categorical Classification; in response to the client request, perform the following steps on a smart server which further interacts with the Database Server and Media Store Server to: determine atomic content, retrieve meta data, store and index meta data, generate unique id #, add media elements to media store server, locate user settings, index and store according to user settings, retrieve and store atomic content.

4. A method as recited in claim 1, the method comprising; of an operation to be performed on a smart server; in response to the client request at a client device, perform the following steps on a smart server which further interacts with the Database Server and Media Store Server to: use location index, retrieve data and meta data; retrieve related URL, supporting URL, content detail URL, and originating URL; and return content with originating URL and like item content.

5. A method as recited in claim 1, the method comprising; of an operation to be performed on a smart server; in response to the client request at a client device, perform the following steps on a smart server which further interacts with the Database Server and Media Store Server to: index client activity.

6. A method as recited in claim 1, the method comprising; of an operation to be performed on a smart server; in response to the client request at a client device, perform the following steps on a smart server which further interacts with appropriate database servers and media servers to: index client activity; receiving at the client device the returned content and like item content.

7. A method as recited in claim 1, the method comprising; of an operation to be performed on a smart server; in response to the client request at a client device, perform the following steps on a smart server which further interacts with the Database Server and Media Store Server to: use location index, retrieve content according to specific search parameters, and return content.

8. A method as recited in claim 1, wherein the client device displays the response via a browser.

9. A method as recited in claim 1, wherein the client device operates on the server data that allows for client side modification of server data received.

10. A method as recited in claim 9, wherein the client device being configured to receive user input that performs a change that requires an operation to be performed on the smart server; respond to the client input by: generating a request for the operation to be performed on the smart server; one or more operations to be performed in response to the request; and sending the response to the client device.

11. A method for a computer readable medium on a client device, the method comprising: receiving user input at a client device that performs a change that requires an operation to be performed on the smart server; in response to the user input, perform the following steps on the client device: generating request for the operation to be performed on the smart server; and sending the request to the smart server; wherein the client device does not block while waiting for the response from the smart server to the request, thereby allowing one or more operations to be performed at the client device after the client device sends the request and before the client device receives the response to the request; receiving the response, processing elements that were generated upon the user input.

12. A method as recited in claim 11, wherein the client device displays the response via a browser.

13. A method as recited in claim 11, wherein the client device operates on the server data that allows for client side modification of server data received.

14. A method as recited in claim 13, wherein the client device being configured to receive user input that performs a change that requires an operation to be performed on the smart server; respond to the client input by: generating a request for the operation to be performed on the smart server; one or more operations to be performed in response to the request; and sending the response to the client device.
